(19) United States
(12) Patent Application Publication
(10) Pub. No.: US 2016/0085006 A1
(43) Pub. Date: Mar. 24, 2016

(54) POLARIZING PLATE WITH PRESSURE-SENSITIVE ADHESIVE LAYER

(71) Applicant: NITTO DENKO CORPORATION, Osaka (JP)

(72) Inventors: Shinsuke Akizuki, Ibaraki-shi (JP); Yuusuke Toyama, Ibaraki-shi (JP)

(73) Assignee: NITTO DENKO CORPORATION, Osaka (JP)

(21) Appl. No.: 14/854,183

(22) Filed: Sep. 15, 2015

(30) Foreign Application Priority Data
Sep. 19, 2014 (JP) 2014-191680

(51) Int. Cl. G02B 5/30; C09J 133/08

(52) U.S. Cl. CPC G02B 5/305; C09J 133/08

(57) ABSTRACT

There is provided a thin polarizing plate with a pressure-sensitive adhesive layer which is excellent in level difference followability and hardly warps. A polarizing plate with a pressure-sensitive adhesive layer of the present invention includes: a protective film, a polarizing film, and a pressure-sensitive adhesive layer in the stated order, wherein: the polarizing plate with a pressure-sensitive adhesive layer has a total thickness of 90 μm or less, the polarizing film has a thickness of 13 μm or less; the pressure-sensitive adhesive layer has a thickness of from 12 μm to 25 μm; and a creep amount when a load of 500 g is applied to the pressure-sensitive adhesive layer for 1 hour is from 80 μm/h to 260 μm/h.

This application claims priority under 35 U.S.C. Section 119 to Japanese Patent Application No. 2014-191680 filed on Sep. 19, 2014, which are herein incorporated by references.

### BACKGROUND OF THE INVENTION

1. Field of the Invention

The present invention relates to a polarizing plate with a pressure-sensitive adhesive layer.

2. Description of the Related Art

In recent years, the thinning of an image display apparatus, in particular, an image display apparatus for mobile applications has been progressing, and hence there has been a growing requirement for the thinning of a polarizing plate to be used in the image display apparatus. Means for thinning the polarizing plate is, for example, a method involving protecting a polarizing film with one protective film (for example, Japanese Patent No. 5332599). However, when the polarizing plate of such construction, i.e., the polarizing plate including the polarizing film having one protected side is bonded to any other member, for example, the following problem occurs. Warping occurs to cause unnecessary peeling or appearance abnormality in an end portion of the polarizing plate in the absorption axis direction of the polarizing film. Such phenomenon becomes a problem particularly in today's circumstances where the image display apparatus is frequently used under a severe environment (e.g., under high temperature and high humidity) in association with the diversification of environments where the apparatus is used including outdoor use of the image display apparatus for mobile applications.

In addition, a polarizing plate of the following construction has been proposed as a thin polarizing plate (for example, International Patent WO2009/069799A). A protective film for protecting a polarizing film is not arranged, and a pressure-sensitive adhesive layer is directly formed on the polarizing film so that the polarizing plate can be bonded to any other member. However, the polarizing plate described in International Patent WO2009/069799A is poor in level difference followability, and hence has a problem in terms of adhesiveness with an uneven surface (e.g., an optical film such as a conductive film having a pattern surface or a level difference caused by a light-shielding layer corresponding to the frame portion of a liquid crystal display panel). When the polarizing plate poor in level difference followability is used, an appearance failure is liable to occur and the problem becomes additionally remarkable in association with the thinning of the polarizing plate. In addition, there is a problem in that it is difficult to bond the polarizing plate described in International Patent WO2009/069799A without the occurrence of air bubbles.

### SUMMARY OF THE INVENTION

The present invention has been made to solve the conventional problems, and a primary object of the present invention is to provide a thin polarizing plate with a pressure-sensitive adhesive layer (more specifically, a polarizing plate in which a protective film is arranged only on one side of a polarizing film), which is excellent in level difference followability and hardly warps.

A polarizing plate with a pressure-sensitive adhesive layer of the present invention includes: a protective film, a polarizing film, and a pressure-sensitive adhesive layer in the stated order, wherein: the polarizing plate with a pressure-sensitive adhesive layer has a total thickness of 90 μm or less, the polarizing film has a thickness of 13 μm or less; the pressure-sensitive adhesive layer has a thickness of from 12 μm to 25 μm; and a creep amount when a load of 500 g is applied to the pressure-sensitive adhesive layer for 1 hour is from 80 μm/h to 260 μm/h.

In one embodiment of the present invention, the pressure-sensitive adhesive layer contains a (meth)acrylic pressure-sensitive adhesive.

In one embodiment of the present invention, when a pressure-sensitive adhesive surface of the polarizing plate with a pressure-sensitive adhesive layer is bonded to a non-alkali glass, and the resultant is left to stand under a 70° C. atmosphere for 200 hours, a shrinkage ratio of the polarizing plate with a pressure-sensitive adhesive layer in an absorption axis direction of the polarizing film is 0.4% or less.

In one embodiment of the present invention, the protective film has a thickness of from 5 μm to 55 μm.

In one embodiment of the present invention, the polarizing plate with a pressure-sensitive adhesive layer has a total thickness of 90 μm or less.

In one embodiment of the present invention, the pressure-sensitive adhesive layer is formed of a pressure-sensitive adhesive containing a base polymer and a plurality of kinds of cross-linking agents; and the plurality of kinds of cross-linking agents each comprise one of a peroxide-based cross-linking agent, an epoxy-based cross-linking agent, and an isocyanate-based cross-linking agent.

According to another aspect of the present invention, there is provided an optical laminate. The optical laminate includes the polarizing plate with a pressure-sensitive adhesive layer; and an optical film arranged on the pressure-sensitive adhesive layer of the polarizing plate with a pressure-sensitive adhesive layer.

In one embodiment of the present invention, the optical film includes a brightness enhancement film.

According to the embodiment of the present invention, the protective film, the polarizing film having a thickness of 13 μm or less, and the pressure-sensitive adhesive layer having a specific thickness and a specific creep amount are arranged in the stated order, whereby a thin polarizing plate with a pressure-sensitive adhesive layer that uses only one protective film is obtained, and a polarizing plate with a pressure-sensitive adhesive layer that hardly warps under high temperature or under high temperature and high humidity despite such construction can be obtained. The polarizing plate with a pressure-sensitive adhesive layer according to the embodiment of the present invention hardly warps, and hence unnecessary peeling, interlayer peeling, and foaming are prevented. In addition, appearance abnormality, specifically appearance abnormality occurring in an end portion of the polarizing plate, appearance abnormality occurring upon its bonding to an uneven surface (e.g., the uneven surface of a panel), appearance abnormality occurring upon its contamination with fine foreign matter, or the like can be prevented.

### BRIEF DESCRIPTION OF THE DRAWINGS

FIG. 1 is a schematic sectional view of a polarizing plate with a pressure-sensitive adhesive layer according to one embodiment of the present invention.

FIG. 2 is a schematic sectional view of an optical laminate according to one embodiment of the present invention.

FIG. 3 is a schematic perspective view for illustrating an example of a linearly polarized light-separating film to be used in the optical laminate of the present invention.

FIG. 4 is a schematic view for illustrating a method of evaluating level difference followability in Examples.

### DETAILED DESCRIPTION OF THE PREFERRED EMBODIMENTS

A. Entire Construction of Polarizing Plate with Pressure-Sensitive Adhesive Layer

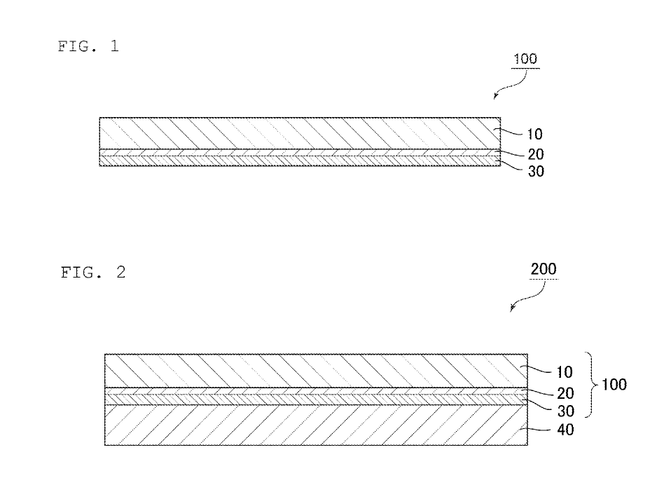

FIG. 1 is a schematic sectional view of a polarizing plate with a pressure-sensitive adhesive layer according to one embodiment of the present invention. A polarizing plate 100 with a pressure-sensitive adhesive layer of FIG. 1 includes a protective film 10, a polarizing film 20, and a pressure-sensitive adhesive layer 30 in the stated order. The polarizing plate with a pressure-sensitive adhesive layer of the present invention includes only one protective film. The protective film 10 and the polarizing film 20 may be laminated through any appropriate adhesive layer, though the layer is not shown. The thickness of the polarizing film 20 is 13 μm or less. The thickness of the pressure-sensitive adhesive layer 30 is from 12 μm to 25 μm. In addition, the polarizing plate with a pressure-sensitive adhesive layer of the present invention can include any appropriate other layer, though the layer is not shown. For example, the plate may include an anchor layer on the surface of the protective film on the polarizing film side. The total thickness of the polarizing plate with a pressure-sensitive adhesive layer is 90 μm or less.

In the present invention, the protective film, the polarizing film, and the pressure-sensitive adhesive layer are arranged in the stated order, and the thicknesses of the polarizing film and the pressure-sensitive adhesive layer are set to specific thicknesses as described above, whereby a polarizing plate with a pressure-sensitive adhesive layer that warps to a small extent can be obtained. In such polarizing plate with a pressure-sensitive adhesive layer, peeling under high temperature and high humidity upon its bonding to any other member, interlayer peeling, and foaming are prevented, and appearance abnormality occurring in an end portion of the polarizing plate can be prevented. Further, in the present invention, as described later, setting the creep amount of the pressure-sensitive adhesive layer to a specific range (from 80 μm/h to 260 μm/h) can provide a polarizing plate with a pressure-sensitive adhesive layer excellent in level difference followability. As the thinning of a polarizing plate that does not have sufficient level difference followability progresses, an appearance failure or the like upon its bonding to an uneven surface tends to be more remarkable. However, the polarizing plate with a pressure-sensitive adhesive layer of the present invention can be thinned (specifically, 90 μm or less as described above) while suppressing the occurrence of the appearance failure or the like because the polarizing plate is excellent in level difference followability.

The total thickness of the polarizing plate with a pressure-sensitive adhesive layer of the present invention is 90 μm or less, preferably from 30 μm to 80 μm, more preferably from 40 μm to 70 μm. In the present invention, even when the polarizing plate is thin, an appearance upon its bonding to an uneven surface is excellent because the polarizing plate is excellent in level difference followability as described above.

When the pressure-sensitive adhesive surface of the polarizing plate with a pressure-sensitive adhesive layer is bonded to a non-alkali glass, and the resultant is left to stand under a 70° C. atmosphere for 200 hours, the shrinkage ratio of the polarizing plate with a pressure-sensitive adhesive layer in the absorption axis direction of the polarizing film is preferably 0.4% or less, more preferably 0.3% or less, still more preferably 0.2% or less. When the shrinkage ratio falls within such range, a polarizing plate that warps to a small extent is obtained, and in the polarizing plate, appearance abnormality occurring in an end portion can be prevented.

B. Polarizing Film

The thickness of the polarizing film is 13 μm or less, preferably 8 μm or less, more preferably 7 μm or less, still more preferably 6 μm or less. The use of such thin polarizing film can provide a thin polarizing plate with a pressure-sensitive adhesive layer. In addition, a polarizing plate with a pressure-sensitive adhesive layer that warps to a small extent can be obtained by suppressing the shrinkage stress of the polarizing film. Meanwhile, the thickness of the polarizing film is preferably 1 μm or more, more preferably 2 μm or more.

The modulus of elasticity of the polarizing film at 25° C. is preferably from 1,000 MPa to 10,000 MPa, more preferably from 2,000 MPa to 7,000 MPa, still more preferably from 2,500 MPa to 4,000 MPa. When the modulus of elasticity falls within such range, a polarizing plate with a pressure-sensitive adhesive layer that warps to a small extent can be obtained. The modulus of elasticity of the polarizing film may be adjusted by, for example, the selection of a material constituting the polarizing film and a stretching ratio upon production of the polarizing film. It should be noted that the modulus of elasticity may be measured in conformity with the tensile test method of JIS K 7127. Specifically, the modulus of elasticity may be measured under the following conditions.

Axis of abscissa upon determination of the modulus of elasticity (slope of a graph): Strain (%)
Axis of ordinate upon determination of the modulus of elasticity (slope of the graph): Tensile stress σ (MPa=N/mm²)=F/initial sectional area A (mm²) of a test piece
Range upon determination of the modulus of elasticity (slope of the graph): Linear regression in the strain range of from 0.05% to 0.25%
Test piece shape: Belt shape (length: 100 mm, width: 50 mm)
Chuck-to-chuck distance: 100 mm

The coefficient of linear expansion of the polarizing film in its absorption axis direction is preferably −50×10⁻⁵/° C. or more, more preferably −10×10⁻⁵/° C. or more. The polarizing film shows a negative coefficient of linear expansion (i.e., shrinks in association with a temperature increase) because the film is formed by stretching as described later. The absolute value of the coefficient of linear expansion of the polarizing film is preferably as small as possible, but an upper limit for the coefficient of linear expansion of the polarizing film in the absorption axis direction is, for example, −1.0×10⁻⁵/° C. or less, and in one embodiment, is −4.0×10⁻⁵/° C. or less. It should be noted that the coefficient of linear expansion is determined in conformity with JIS K 7197.

The polarizing film preferably exhibits absorption dichroism at any wavelength in the wavelength range of from 380 nm to 780 nm. The polarizing film has a single axis transmittance of preferably 40.0% or more, more preferably 41.0% or more, still more preferably 42.0% or more, particularly preferably 43.0% or more. The polarizing film has a polarization degree of preferably 99.8% or more, more preferably 99.9% or more, still more preferably 99.95% or more.

The polarizing film is preferably an iodine-based polarizing film. More specifically, the polarizing film may be formed of an iodine-containing polyvinyl alcohol-based resin (hereinafter referred to as “PVA-based resin”) film.

Any appropriate resin may be adopted as a PVA-based resin for forming the PVA-based resin film. Examples of the resin include polyvinyl alcohol and an ethylene-vinyl alcohol copolymer. The polyvinyl alcohol is obtained by saponifying polyvinyl acetate. The ethylene-vinyl alcohol copolymer is obtained by saponifying an ethylene-vinyl acetate copolymer. The saponification degree of the PVA-based resin is typically from 85 mol % to 100 mol %, preferably from 95.0 mol % to 99.95 mol %, more preferably from 99.0 mol % to 99.93 mol %. The saponification degree may be determined in conformity with JIS K 6726-1994. The use of the PVA-based resin having such saponification degree can provide a polarizing film excellent in durability. When the saponification degree is excessively high, gelling may occur.

The average polymerization degree of the PVA-based resin may be appropriately selected depending on purposes. The average polymerization degree is typically from 1,000 to 10,000, preferably from 1,200 to 5,000, more preferably from 1,500 to 4,500. It should be noted that the average polymerization degree may be determined in conformity with JIS K 6726-1994.

A method of producing the polarizing film is, for example, a method (I) including stretching and dyeing a PVA-based resin film alone, or a method (II) including stretching and dyeing a laminate (i) having a resin base material and a polyvinyl alcohol-based resin layer. Detailed description of the method (I) is omitted because the method is well known and conventionally used in the art. The production method (II) preferably includes the step of stretching and dyeing the laminate (i) having the resin base material and the polyvinyl alcohol-based resin layer formed on one side of the resin base material to produce a polarizing film on the resin base material. The laminate (i) may be formed by applying an application liquid containing a polyvinyl alcohol-based resin onto the resin base material and drying the applied liquid. In addition, the laminate (i) may be formed by transferring a polyvinyl alcohol-based resin film onto the resin base material. For example, Japanese Patent Application Laid-open No. 2012-73580 describes details about the production method (II), and is incorporated herein by reference.

C. Protective Film

Any appropriate resin film may be adopted as the protective film. As a material for forming the protective film, there are given, for example: a cellulose-based resin such as triacetylcellulose (TAC); a cycloolefin-based resin such as a norbornene-based resin; an olefin-based resin such as polyethylene or polypropylene; a polyester-based resin; and a (meth)acrylic resin. It should be noted that the term “(meth)acrylic resin” refers to an acrylic resin and/or a methacrylic resin.

In one embodiment, a (meth)acrylic resin having a glutarimide structure is used as the (meth)acrylic resin. The (meth)acrylic resin having a glutarimide structure (hereinafter sometimes referred to as glutarimide resin) is described in, for example, Japanese Patent Application Laid-open No. 2006-309033, Japanese Patent Application Laid-open No. 2006-317560, Japanese Patent Application Laid-open No. 2006-328329, Japanese Patent Application Laid-open No. 2006-328334, Japanese Patent Application Laid-open No. 2006-337491, Japanese Patent Application Laid-open No. 2006-337492, Japanese Patent Application Laid-open No. 2006-337493, Japanese Patent Application Laid-open No. 2006-337569, Japanese Patent Application Laid-open No. 2007-009182, Japanese Patent Application Laid-open No. 2009-161744, and Japanese Patent Application Laid-open No. 2010-284840. The descriptions thereof are incorporated herein by reference.

The resin film is formed by any appropriate method. Examples of the film-forming method include a melt extrusion method, a solution casting method, a calender method, and a compression forming method. Of those, a melt extrusion method is preferred. In addition, the resin film may be subjected to a stretching treatment.

The protective film and the polarizing film are laminated through any appropriate adhesive layer. A resin base material used at the time of the production of the polarizing film may be peeled before the lamination of the protective film and the polarizing film, or after the lamination.

The thickness of the protective film is preferably from 5 μm to 55 μm, more preferably from 10 μm to 50 μm, still more preferably from 15 μm to 45 μm. When the thickness falls within such range, a polarizing plate with a pressure-sensitive adhesive layer that warps to a small extent can be obtained. It should be noted that the protective film may be subjected to various surface treatments.

The modulus of elasticity of the protective film at 25° C. is preferably from 1,000 MPa to 10,000 MPa, more preferably from 1,200 MPa to 5,000 MPa, still more preferably from 1,300 MPa to 4,000 MPa. When the modulus of elasticity falls within such range, a polarizing plate with a pressure-sensitive adhesive layer that warps to a small extent can be obtained.

The coefficient of linear expansion of the protective film is preferably more than 0/° C., more preferably from 1.0×10⁻⁶/° C. to 50×10⁻⁶/° C., still more preferably from 4.0×10⁻⁶/° C. to 10×10⁻⁶/° C. When the coefficient of linear expansion falls within such range, a polarizing plate with a pressure-sensitive adhesive layer that warps to a small extent can be obtained. It should be noted that when the protective film has anisotropy, the term “coefficient of linear expansion of the protective film” means a coefficient of linear expansion in a machine direction (MD, the absorption axis direction of the polarizing film in the polarizing plate with a pressure-sensitive adhesive layer) at the time of the production of the protective film.

The moisture permeability of the protective film is preferably 1,000 g/m²/24 h or less, more preferably 100 g/m²/24 h or less, still more preferably 90 g/m²/24 h or less. When the moisture permeability falls within such range, the deterioration of the polarizing film due to moisture can be prevented. It should be noted that the “moisture permeability” is a value determined by measuring the amount (g) of water vapor that passes a sample having an area of 1 m² within 24 hours in an atmosphere having a temperature of 40° C. and a humidity of 92% RH in conformity with the moisture permeability test (cup method) of JIS Z 0208.

D. Pressure-Sensitive Adhesive Layer

The polarizing plate with a pressure-sensitive adhesive layer of the present invention includes the pressure-sensitive adhesive layer on the surface of the polarizing film on a side opposite to the protective film, i.e., the outermost side, and can be bonded to any other member through the pressure-sensitive adhesive layer.

A creep amount when a load of 500 g is applied to the pressure-sensitive adhesive layer for 1 hour is from 80 μm/h to 260 μm/h, preferably from 100 μm/h to 200 μm/h. In the polarizing plate with a pressure-sensitive adhesive layer including the pressure-sensitive adhesive layer showing a creep amount in such range, the pressure-sensitive adhesive layer and the polarizing film can deform in phase with a temperature change. Accordingly, a stress to be applied to the polarizing film can be alleviated and hence a polarizing plate with a pressure-sensitive adhesive layer excellent in adhesiveness can be obtained. In addition, when the creep amount of the pressure-sensitive adhesive layer falls within the range, a polarizing plate with a pressure-sensitive adhesive layer excellent in level difference followability can be obtained. A specific method of measuring the creep amount is described later.

The pressure-sensitive adhesive layer may be formed of a pressure-sensitive adhesive containing a pressure-sensitive adhesive base polymer and a cross-linking agent. The creep amount of the pressure-sensitive adhesive layer may be adjusted by, for example, the molecular weight of the base polymer in the pressure-sensitive adhesive and the addition amount of the cross-linking agent in the pressure-sensitive adhesive. More specifically, the creep amount of the pressure-sensitive adhesive layer may be reduced by using a polymer having a high molecular weight as the base polymer and/or increasing the addition amount of the cross-linking agent. In addition, the creep amount of the pressure-sensitive adhesive layer may be increased by using a polymer having a low molecular weight as the base polymer and/or reducing the addition amount of the cross-linking agent.

The thickness of the pressure-sensitive adhesive layer is preferably from 12 μm to 25 μm, more preferably from 13 μm to 23 μm. When the thickness falls within such range, a polarizing plate with a pressure-sensitive adhesive layer that is thin and excellent in level difference followability can be obtained.

The storage modulus of the pressure-sensitive adhesive layer at 25° C. is preferably from 0.03 MPa to 0.14 MPa, more preferably from 0.05 MPa to 0.13 MPa, still more preferably from 0.08 MPa to 0.13 MPa. When the storage modulus falls within such range, a polarizing plate with a pressure-sensitive adhesive layer that can be prevented from, for example, peeling and foaming, and is excellent in durability can be obtained. It should be noted that the storage modulus may be determined by subjecting a pressure-sensitive adhesive layer sample measuring 2 mm in thickness by 8 mm in diameter to dynamic viscoelasticity measurement (with, for example, “Advanced Rheometric Expansion System (ARES)” manufactured by Rheometric Scientific, deformation mode: distortion, measurement frequency: 1 Hz, rate of temperature increase: 5° C./min, measurement temperature: −50° C. to 150° C.).

Examples of the pressure-sensitive adhesive include a (meth)acrylic pressure-sensitive adhesive, an acrylic urethane-based pressure-sensitive adhesive, a urethane-based pressure-sensitive adhesive, a silicone-based pressure-sensitive adhesive, and an organic-inorganic hybrid pressure-sensitive adhesive. Of those, a (meth)acrylic pressure-sensitive adhesive is preferred from the viewpoints of transparency and durability.

An examples of the (meth)acrylic pressure-sensitive adhesive is a (meth)acrylic pressure-sensitive adhesive whose base polymer is a (meth)acrylic polymer (homopolymer or copolymer) using as a monomer component one kind or two or more kinds of (meth)acrylic acid alkylesters. Specific examples of the (meth)acrylic acid alkyl ester include (meth)acrylic acid C1-20 alkyl esters such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Of those, a (meth)acrylic acid alkyl ester having a linear or branched alkyl group having 4 to 18 carbon atoms may be preferably used. The content of a constituent unit derived from the (meth)acrylic acid alkyl ester is preferably 60 parts by weight or more, more preferably 80 parts by weight or more with respect to 100 parts by weight of the base polymer.

The (meth)acrylic polymer may contain a constituent unit derived from any other monomer component copolymerizable with the (meth)acrylic acid alkyl ester as required for the purpose of modification of cohesive strength, heat resistance, cross-linkability, or the like. Examples of such monomer component include: carboxyl group-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl group-containing monomers such as hydroxyethyl (meth)acrylate, hydroxypropyl (meth)acrylate, hydroxybutyl (meth)acrylate, hydroxyhexyl (meth)acrylate, hydroxyoctyl (meth)acrylate, hydroxydecyl (meth)acrylate, hydroxylauryl (meth)acrylate, and (4-hydroxymethylcyclohexyl)methyl methacrylate; and sulfonic acid group-containing monomers such as styrenesulfonic acid, allylsulfonic acid, 2-(meth)acrylamide-2-methylpropanesulfonic acid, (meth)acrylamidopropanesulfonic acid, sulfopropyl (meth)acrylate, and (meth)acryloyloxynaphthalenesulfonic acid.

In addition, an aromatic ring-containing alkyl (meth)acrylate such as phenoxyethyl (meth)acrylate or benzyl (meth)acrylate may be used from the viewpoints of pressure-sensitive adhesive properties, durability, control of retardation, control of refractive index, and the like. A polymer obtained by polymerizing the aromatic ring-containing alkyl (meth)acrylate may be used by being mixed with the (meth)acrylic polymer exemplified above. The aromatic ring-containing alkyl (meth)acrylate is preferably used by being copolymerized with the alkyl (meth)acrylate from the viewpoint of transparency.

In addition, as monomers for property modification, there are given, for example: an (N-substituted) amide-based monomer such as (meth)acrylamide, N,N-dimethyl(meth)acrylamide, N-butyl(meth)acrylamide, N-methylol(meth)acrylamide, or N-methylolpropane(meth)acrylamide; an alkylaminoalkyl (meth)acrylate-based monomer such as aminoethyl (meth)acrylate, N,N-dimethylaminoethyl (meth)acrylate, or t-butylaminoethyl (meth)acrylate; an alkoxyalkyl (meth)acrylate-based monomer such as methoxyethyl (meth)acrylate or ethoxyethyl (meth)acrylate; a succinimide-based monomer such as N-(meth)acryloyloxymethylenesuccinimide, N-(meth)acryloyl-6-oxyhexamethylenesuccinimide, N-(meth)acryloyl-8-oxyoctamethylenesuccinimide, or N-acryloylmorpholine; a maleimide-based monomer such as N-cyclohexylmaleimide, N-isopropylmaleimide, N-laurylmaleimide, or N-phenylmaleimide; and an itaconimide-based monomer such as N-methylitaconimide, N-ethylitaconimide, N-butylitaconimide, N-octylitaconimide, N-2-ethylhexylitaconimide, N-cyclohexylitaconimide, or N-laurylitaconimide.

Further, as the monomers for property modification, there may also be used, for example: vinyl-based monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate-based monomers such as acrylonitrile and methacrylonitrile; epoxy group-containing acrylic monomers such as glycidyl (meth)acrylate; glycol-based acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylic acid ester-based monomers such as tetrahydrofurfuryl (meth)acrylate, a fluorinated (meth)acrylate, a silicone (meth)acrylate, and 2-methoxyethyl acrylate. Further, there are given, for example, isoprene, butadiene, isobutylene, and vinyl ether.

Further, as the copolymerizable monomer except the ones described above, there is given, for example, a silane-based monomer, which contains a silicon atom. Examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

In one embodiment, the base polymer is substantially free of a constituent unit derived from a carboxyl group-containing monomer. The use of such base polymer can provide a polarizing plate with a pressure-sensitive adhesive layer that can suppress the deterioration of an adherend. It should be noted that the phrase “substantially free” means that the content of the constituent unit derived from a carboxyl group-containing monomer is 0.7 wt % or less with respect to all constituent units constituting the base polymer. The content of the constituent unit derived from a carboxyl group-containing monomer is preferably 0.5 wt % or less, more preferably 0.3 wt % or less, still more preferably 0.1 wt % or less with respect to all constituent units constituting the base polymer, and it is most preferred that the base polymer be free of the constituent unit derived from a carboxyl group-containing monomer.

The weight-average molecular weight of the base polymer is preferably from 800,000 to 3,000,000, more preferably from 1,000,000 to 2,500,000, still more preferably from 1,400,000 to 2,000,000. When the weight-average molecular weight falls within such range, the pressure-sensitive adhesive layer that shows an appropriate creep amount can be formed. It should be noted that the weight-average molecular weight is determined from a value measured by gel permeation chromatography (GPC; solvent: THF) and calculated in terms of polystyrene.

Examples of the cross-linking agent include an isocyanate-based cross-linking agent, an epoxy-based cross-linking agent, a peroxide-based cross-linking agent, a melamine-based cross-linking agent, a urea-based cross-linking agent, a metal alkoxide-based cross-linking agent, a metal chelate-based cross-linking agent, a metal salt-based cross-linking agent, a carbodiimide-based cross-linking agent, an oxazoline-based cross-linking agent, an aziridine-based cross-linking agent, and a amine-based cross-linking agent. Of those, an isocyanate-based cross-linking agent, an epoxy-based cross-linking agent, and/or a peroxide-based cross-linking agent is preferably used. The cross-linking agents may be used alone or in combination.

It is preferred that the pressure-sensitive adhesive contain as the cross-linking agent a plurality of kinds of cross-linking agents. It is more preferred that the plurality of kinds of cross-linking agents be selected from the group consisting of a peroxide-based cross-linking agent, an epoxy-based cross-linking agent, and an isocyanate-based cross-linking agent. The combined use of the plurality of kinds of cross-linking agents as just described allows the creep amount of the pressure-sensitive adhesive layer to be adjusted appropriately and easily.

Any appropriate cross-linking agent may be used as the isocyanate-based cross-linking agent. Examples of the isocyanate-based cross-linking agent include: isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate; and an isocyanate compound obtained by addition of a polyol such as trimethylolpropane to any one of the isocyanate monomers.

Any appropriate cross-linking agent may be used as the epoxy-based cross-linking agent. For example, an epoxy-based resin having in its molecule two or more epoxy groups is used as the epoxy-based cross-linking agent. Specific examples thereof include diglycidylaniline, 1,3-bis(N,N-glycidylaminomethyl)cyclohexane, N,N,N′,N′-tetraglycidyl-m-xylenediamine, 1,6-hexanediol diglycidyl ether, neopentyl glycol diglycidyl ether, ethylene glycol diglycidyl ether, and propylene glycol diglycidyl ether.

Any appropriate cross-linking agent may be used as the peroxide-based cross-linking agent. Examples of the peroxide-based cross-linking agent include dibenzoyl peroxide, di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, and t-butyl peroxypivalate.

The addition amount of the cross-linking agent is preferably from 0.01 part by weight to 5 parts by weight, more preferably from 0.02 part by weight to 3 parts by weight, still more preferably from 0.1 part by weight to 2.5 parts by weight, particularly preferably from 0.4 part by weight to 1 part by weight with respect to 100 parts by weight of the base polymer.

In one embodiment, the pressure-sensitive adhesive for forming the pressure-sensitive adhesive layer may further contain an ionic compound. The ionic compound has an anion component and a cation component. The addition of the ionic compound allows the formation of the pressure-sensitive adhesive layer having an antistatic function.

Examples of the anion component include a bis(heptafluoropropanesulfonyl)imide anion, a bis(nonafluorobutanesulfonyl)imide anion, a bis(undecafluoropentanesulfonyl)imide anion, a bis(tridecafluorohexanesulfonyl)imide anion, a bis(pentadecafluoroheptanesulfonyl)imide anion, a cyclo-hexafluoropropane-1,3-bis(sulfonyl)imide anion, a hexafluoropropane-1,3-disulfonic acid anion, a bis(trifluoromethanesulfonyl)imide anion, a trifluoromethanesulfonyl anion, and a pentafluoroethanesulfonyl anion. Of those, a bis(trifluoromethanesulfonyl)imide anion is preferred.

Examples of the cation component include alkali metal ions of lithium, sodium, and potassium. Of those, a lithium ion is preferred. An alkali metal salt as the ionic compound may be formed of the anion component and the cation component.

An organic cation may be used as the cation component. Specific examples of the organic cation include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, and a tetraalkylphosphonium cation. Of those organic cations, a pyrrolidinium cation is preferred.

The addition amount of the ionic compound is preferably from 0.1 part by weight to 5 parts by weight, more preferably from 0.5 part by weight to 3 parts by weight with respect to 100 parts by weight of the base polymer.

In one embodiment, the pressure-sensitive adhesive for forming the pressure-sensitive adhesive layer may further contain a silane coupling agent. Examples of the silane coupling agent include: epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acrylic group-containing silane coupling agents; and isocyanate group-containing silane coupling agents.

The addition amount of the silane coupling agent is preferably from 0.01 part by weight to 1 part by weight, more preferably from 0.05 part by weight to 0.5 part by weight with respect to 100 parts by weight of the base polymer.

The pressure-sensitive adhesive may further contain any appropriate additive as required. Examples of the additive include a tackifier, a plasticizer, a pigment, a dye, a filler, an anti-aging agent, a conductive material, an ultraviolet absorber, a photostabilizer, a peeling adjusting agent, a softener, a surfactant, a flame retardant, and an antioxidant.

E. Method of Producing Polarizing Plate with Pressure-Sensitive Adhesive Layer

The polarizing plate with a pressure-sensitive adhesive layer may be produced by any appropriate production method. The method of producing the polarizing plate with a pressure-sensitive adhesive layer includes, for example, the steps of: laminating the polarizing film and the protective film; and forming the pressure-sensitive adhesive layer on the polarizing film. In one embodiment, the polarizing plate with a pressure-sensitive adhesive layer may be formed into an elongated shape (e.g., 300 m or more).

In one embodiment, the lamination of the polarizing film and the protective film is performed by a roll-to-roll process. It is preferred that an elongated polarizing film that is obtained in a method of producing a polarizing film to be described in the section B-1 through a MD stretching step and has an absorption axis in its lengthwise direction, and an elongated protective film be laminated through an adhesive layer to provide a laminate of the polarizing film and the protective film. The lamination of the polarizing film and the protective film is preferably performed under heating. When an adhesive (described later) constituting the adhesive layer is an aqueous adhesive or a solvent-based adhesive, a heating temperature is a temperature at which the adhesive dries, and when the adhesive is an active energy ray-curable adhesive, the heating temperature is a temperature at which the adhesive cures. The heating temperature is preferably 50° C. or more, more preferably 55° C. or more, still more preferably 60° C. or more. Meanwhile, the heating temperature is preferably 80° C. or less. It should be noted that the heating to be performed upon lamination of the protective film may also serve as a drying treatment for the laminate. The thickness of the adhesive layer is preferably from 0.01 μm to 7 μm, more preferably from 0.01 μm to 5 μm, still more preferably from 0.01 μm to 2 μm, most preferably from 0.01 μm to 1 μm.

The adhesive layer for bonding the polarizing film and the protective film is formed of any appropriate adhesive. The adhesive may be an aqueous adhesive, may be a solvent-based adhesive, or may be an active energy ray-curable adhesive.

Any appropriate adhesive may be used as the active energy ray-curable adhesive as long as the adhesive can be cured by being irradiated with an active energy ray. Examples of the active energy ray-curable adhesive include a UV-curable adhesive and an electron beam-curable adhesive. Specific examples of the curing type of the active energy ray-curable adhesive include a radical curing type, a cation curing type, an anion curing type, and a combination thereof (e.g., a hybrid of the radical curing type and the cation curing type).

Examples of the active energy ray-curable adhesive include adhesives containing, as curable components, compounds (such as monomers and/or oligomers) each having a radically polymerizable group such as a (meth)acrylate group or a (meth)acrylamide group.

Specific examples of the active energy ray-curable adhesive and a method of curing the adhesive are described in, for example, Japanese Patent Application Laid-open No. 2012-144690. The description is incorporated herein by reference.

Any appropriate aqueous adhesive may be adopted as the aqueous adhesive. An aqueous adhesive containing a PVA-based resin is preferably used. The average polymerization degree of the PVA-based resin to be incorporated into the aqueous adhesive is preferably from about 100 to 5,500, more preferably from 1,000 to 4,500 in terms of an adhesive property. The average saponification degree of the PVA-based resin is preferably from about 85 mol % to 100 mol %, more preferably from 90 mol % to 100 mol % in terms of the adhesive property.

The PVA-based resin to be incorporated into the aqueous adhesive preferably contains an acetoacetyl group. This is because adhesiveness between a PVA-based resin layer and the protective film is excellent, and the polarizing plate can be excellent in durability. An acetoacetyl group-containing PVA-based resin is obtained by, for example, causing the PVA-based resin and diketene to react with each other according to any appropriate method. The acetoacetyl group modification degree of the acetoacetyl group-containing PVA-based resin is typically 0.1 mol % or more, preferably from about 0.1 mol % to 40 mol %, more preferably from 1 mol % to 20 mol %, still more preferably from 1 mol % to 7 mol %. It should be noted that the acetoacetyl group modification degree is a value measured by NMR.

The resin concentration of the aqueous adhesive is preferably from 0.1 wt % to 15 wt %, more preferably from 0.5 wt % to 10 wt %.

In the step of forming the pressure-sensitive adhesive layer on the polarizing film, the pressure-sensitive adhesive layer is formed by, for example, applying the pressure-sensitive adhesive described in the section D onto the polarizing film and then cross-linking (polymerizing) the pressure-sensitive adhesive. Any appropriate method may be adopted as a method for the cross-linking. In addition, the pressure-sensitive adhesive layer formed on another base material may be transferred onto the polarizing film.

In one embodiment, an anchor layer is arranged on the surface of the protective film on the polarizing film side. Arranging the anchor layer can improve adhesiveness between the protective film and the polarizing film. A material for forming the anchor layer is not particularly limited, and various polymers, gels of metal oxides, silica sol, or the like may be used. Of those, polymers are preferred. The form of each of the polymers may be any of a solvent-soluble type, a water-dispersion type, or a water-soluble type.

The anchor layer may further contain any appropriate additive as required. Examples of the additive include an antistatic agent, an antioxidant, an ultraviolet absorber, a pH adjusting agent, a deterioration inhibitor, and a surfactant.

The antistatic agent is not particularly limited as long as it is a material that can impart conductivity, and examples thereof include an ionic surfactant, a conductive polymer, a metal oxide, carbon black, and a carbon nanomaterial. Of those, a conductive polymer is preferred, and a water-dispersible conductive polymer is more preferred.

Any appropriate method may be adopted as a method of forming the anchor layer. In addition, the protective film may be subjected to an activation treatment before the formation of the anchor layer. Examples of the activation treatment include a corona treatment, a low-pressure UV treatment, and a plasma treatment.

The thickness of the anchor layer is preferably from 5 nm to 300 nm from the viewpoint of thinning.

F. Optical Laminate

FIG. 2 is a schematic sectional view of an optical laminate according to one embodiment of the present invention. An optical laminate 200 of FIG. 2 includes the polarizing plate 100 with a pressure-sensitive adhesive layer and an optical film 40. The polarizing plate with a pressure-sensitive adhesive layer described in the sections A to D may be used as the polarizing plate 100 with a pressure-sensitive adhesive layer. That is, the polarizing plate 100 with a pressure-sensitive adhesive layer includes the protective film 10, the polarizing film 20, and the pressure-sensitive adhesive layer 30 in the stated order. The optical film 40 is arranged on the pressure-sensitive adhesive layer 30, that is, on the surface of the pressure-sensitive adhesive layer 30 on a side opposite to the polarizing film 20. When the optical laminate is constituted by combining the polarizing plate with a pressure-sensitive adhesive layer and the optical film (the coefficient of linear expansion of the polarizing film in its absorption axis direction is positive in the optical laminate), the warping of the polarizing plate with a pressure-sensitive adhesive layer is suppressed by the optical film, and hence the effects of the present invention become additionally significant. In addition, the polarizing film can be protected with the optical film.

The thickness of the optical laminate is preferably 100 μm or less, more preferably 90 μm or less, still more preferably from 40 μm to 80 lam.

When the surface of the optical laminate on the protective film side and a non-alkali glass are bonded to each other through a pressure-sensitive adhesive, and the optical laminate is placed under a 70° C. environment for 200 hours, the shrinkage ratio of the optical laminate in the absorption axis direction of the polarizing film is preferably 0.4% or less, more preferably 0.3% or less, still more preferably 0.2% or less. When the shrinkage ratio falls within such range, an optical laminate that warps to a small extent is obtained, and in the optical laminate, appearance abnormality occurring in an end portion of the polarizing plate can be prevented. Any appropriate pressure-sensitive adhesive may be used as the pressure-sensitive adhesive.

G. Optical Film

Any appropriate optical film may be used as the optical film depending on the applications of the optical laminate. Examples of the optical film include: brightness enhancement films; retardation films; and films with surface-treated layers having various surface-treated layers such as a hard coat layer, an antiglare layer, and an antireflection layer. Of those, a brightness enhancement film is preferred.

The thickness of the optical film is preferably from 10 μm to 30 μm, more preferably from 10 μm to 25 μm, still more preferably from 12 μm to 22 μm.

The moisture permeability of the optical film is preferably 500 g/m²/24 h or less, more preferably 300 g/m²/24 h or less, still more preferably from 1 g/m²/24 h to 100 g/m²/24 h. When the moisture permeability falls within such range, the deterioration of the polarizing film due to moisture can be prevented.

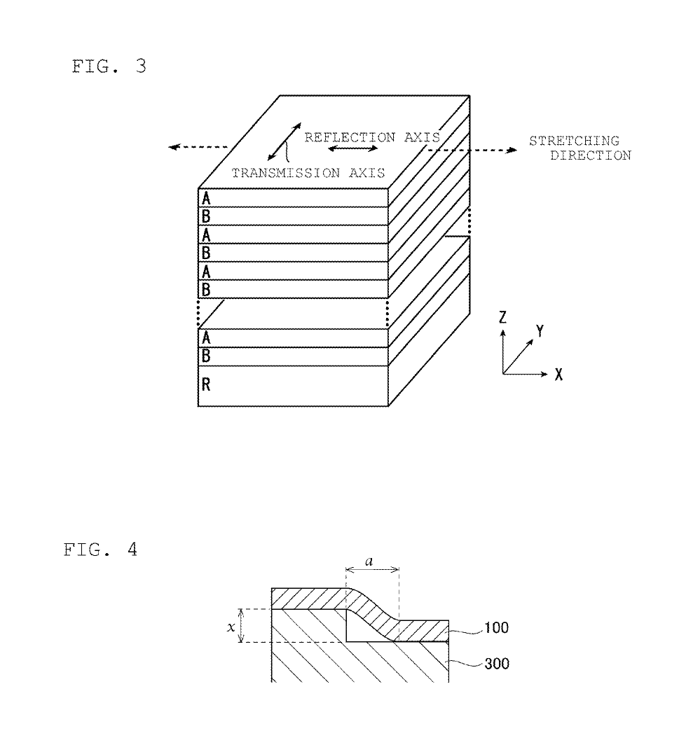

In one embodiment, a linearly polarized light-separating film is used as the brightness enhancement film. FIG. 3 is a schematic perspective view for illustrating an example of the linearly polarized light-separating film. The linearly polarized light-separating film is preferably a multilayer laminate in which a layer A having birefringence and a layer B having substantially no birefringence are alternately laminated. In, for example, the illustrated example, a refractive index n(X) of the layer A in an X-axis direction is larger than a refractive index n(Y) thereof in a Y-axis direction, and the refractive index n(X) of the layer B in the X-axis direction and the refractive index n(Y) thereof in the Y-axis direction are substantially the same. Therefore, a difference in refractive index between the layer A and the layer B is large in the X-axis direction, and is substantially zero in the Y-axis direction. As a result, the X-axis direction serves as a reflection axis and the Y-axis direction serves as a transmission axis. The difference in refractive index between the layer A and the layer B in the X-axis direction is preferably from 0.2 to 0.3.

The layer A is preferably formed of a material that expresses birefringence through stretching. Typical examples of such material include naphthalene dicarboxylic acid polyester (such as polyethylene naphthalate), polycarbonate, and an acrylic resin (such as polymethyl methacrylate). Of those, polyethylene naphthalate or polycarbonate is preferred in terms of low moisture permeability. The layer B is preferably formed of a material that expresses substantially no birefringence even when stretched. Such material is typically, for example, the copolyester of naphthalene dicarboxylic acid and terephthalic acid.

At an interface between the layer A and the layer B, the linearly polarized light-separating film transmits light having a first polarization direction (such as a p-wave), and reflects light having a second polarization direction perpendicular to the first polarization direction (such as an s-wave). At the interface between the layer A and the layer B, part of the reflected light is transmitted as light having the first polarization direction, and the other part thereof is reflected as light having the second polarization direction. Such reflection and transmission are repeated many times in the linearly polarized light-separating film, and hence the utilization efficiency of light can be improved.

The linearly polarized light-separating film preferably includes a reflective layer R as the outermost layer opposite to the polarizing film as illustrated in FIG. 3. Arranging the reflective layer R enables additional utilization of light that has finally returned to the outermost portion of the linearly polarized light-separating film without being utilized, and hence can additionally improve the utilization efficiency of light. The reflective layer R typically expresses its reflecting function by virtue of the multilayer structure of a polyester resin layer.

The linearly polarized light-separating film and the polarizing film are preferably laminated so that the transmission axis of the linearly polarized light-separating film and the absorption axis of the polarizing film may be substantially perpendicular to each other. The phrase “substantially perpendicular” as used herein comprehends the case where an angle formed between the two optical axes is 90°±2°, and the angle is preferably 90°±1°.

The entire thickness of the linearly polarized light-separating film may be appropriately set depending on, for example, a purpose and the total number of layers in the linearly polarized light-separating film. The entire thickness of the linearly polarized light-separating film is preferably 30 μm or less, more preferably from 10 μm to 30 μm, still more preferably from 20 μm to 30 μm.

For example, a film described in Japanese Patent Translation Publication No. Hei 9-507308 may be used as the linearly polarized light-separating film.

A commercial product may be used as it is as the linearly polarized light-separating film, or a product obtained by subjecting the commercial product to secondary processing (such as stretching) may be used. Examples of the commercial product include a product available under the trade name “DBEF” from 3M Company and a product available under the trade name “APF” from 3M Company.

### EXAMPLES

The present invention is specifically described below by way of Examples. However, the present invention is not limited to Examples below.

### Production Example 1

### Protective Film

### Production of Acrylic Film

A methacrylic resin pellet having a glutarimide ring unit was dried at 100.5 kPa and 100° C. for 12 hours, and was extruded by using a uniaxial extruder from a T-die at a die temperature of 270° C. to be formed into a film shape. Further, the film was stretched in its conveying direction under an atmosphere having a temperature higher than the Tg of the resin by 10° C., and was then stretched in a direction perpendicular to the film-conveying direction under an atmosphere having a temperature higher than the Tg of the resin by 7° C. to provide a protective film A constituted of an acrylic resin (thickness: 40 μm).

Similarly, a protective film B having a thickness of 50 μm was obtained.

### Production Example 2

### Production of Laminate (A-1)

An amorphous isophthalic acid-copolymerized polyethylene terephthalate (IPA-copolymerized PET) film of an elongated shape having a coefficient of water absorption of 0.75% and a Tg of 75° C. (thickness: 100 μm) was used as a thermoplastic resin base material.

One surface of the resin base material was subjected to a corona treatment. An aqueous solution containing polyvinyl alcohol (polymerization degree: 4,200, saponification degree: 99.2 mol %) and acetoacetyl-modified PVA (polymerization degree: 1,200, acetoacetyl modification degree: 4.6%, saponification degree: 99.0 mol % or more, manufactured by The Nippon Synthetic Chemical Industry Co., Ltd., trade name: “GOHSEFIMER Z-200”) at a ratio of 9:1 was applied to the corona-treated surface at 25° C. and dried to form a PVA-based resin layer having a thickness of 11 μm. Thus, a laminate a was produced.

The resultant laminate a was subjected to free-end uniaxial stretching at a stretching ratio of 2.0 times in its longitudinal direction (lengthwise direction) between rolls having different peripheral speeds in an oven at 120° C. (aerial auxiliary stretching).

Next, the laminate a was immersed in an insolubilizing bath having a liquid temperature of 30° C. (aqueous solution of boric acid obtained by compounding 100 parts by weight of water with 4 parts by weight of boric acid) for 30 seconds (insolubilizing treatment).

Next, the laminate a was immersed in a dyeing bath having a liquid temperature of 30° C. while its iodine concentration and an immersion time were adjusted so that the polarizing film had a predetermined transmittance. In this example, the laminate was immersed in an aqueous solution of iodine obtained by compounding 100 parts by weight of water with 0.2 part by weight of iodine and 1.0 part by weight of potassium iodide for 60 seconds (dyeing treatment).

Next, the laminate a was immersed in a cross-linking bath having a liquid temperature of 30° C. (aqueous solution of boric acid obtained by compounding 100 parts by weight of water with 3 parts by weight of potassium iodide and 3 parts by weight of boric acid) for 30 seconds (cross-linking treatment).

After that, the laminate a was subjected to uniaxial stretching so as to achieve a total stretching ratio of 5.5 times in the longitudinal direction (lengthwise direction) between rolls having different peripheral speeds while being immersed in an aqueous solution of boric acid having a liquid temperature of 70° C. (aqueous solution obtained by compounding 100 parts by weight of water with 4 parts by weight of boric acid and 5 parts by weight of potassium iodide) (underwater stretching).

After that, the laminate a was immersed in a washing bath having a liquid temperature of 30° C. (aqueous solution obtained by compounding 100 parts by weight of water with 4 parts by weight of potassium iodide) (washing treatment).

Subsequently, an aqueous solution of a PVA-based resin (manufactured by The Nippon Synthetic Chemical Industry Co., Ltd., trade name: “GOHSEFIMER (trademark) Z-200”, resin concentration: 3 wt %) was applied to the surface of the PVA-based resin layer of the laminate a so as to have a thickness of 0.5 μm after drying, and the protective film A obtained in Production Example 1 (thickness: 40 μm) was laminated on the applied solution. After that, the resultant was heated in an oven maintained at 60° C. for 5 minutes. Thus, a laminate A-1 having a polarizing film having a thickness of 5 μm (protective film (40 μm)/polarizing film (5 μm)/thermoplastic resin base material) was produced.

### Production Example 3

### Production of Laminate (A-2)

A laminate A-2 (protective film (50 μm)/polarizing film (5 μm)/thermoplastic resin base material) was produced in the same manner as in Production Example 2 except that the protective film B (thickness: 50 μm) was used instead of the protective film A (thickness: 40 μm).

### Production Example 4

### Production of Laminate (A-3)

A laminate A-3 (protective film (40 μm)/polarizing film (20 μm)/thermoplastic resin base material) was produced in the same manner as in Production Example 2 except that a polarizing film having a thickness of 20 μm was produced.

### Production Example 5

### Production of Laminate (A-4)

A laminate a-4 (protective film (40 μm)/polarizing film (5 μm)/thermoplastic resin base material) was produced in the same manner as in Production Example 2.

After the thermoplastic resin base material had been peeled from the laminate a-4, the protective film A (thickness: 40 μm) was laminated as another protective film on the polarizing film by the same method as that described in Production Example 2. Thus, a laminate A-4 (protective film (40 μm)/polarizing film (5 μm)/another protective film (40 μm)) was produced.

### Production Example 6

### Preparation of (Meth)Acrylic Polymer (B-1)

99 Parts by weight of butyl acrylate, 1 part by weight of 4-hydroxybutyl acrylate, and 1 part by weight of AIBN as an initiator were loaded into a reaction vessel mounted with a cooling tube, a nitrogen-introducing tube, a temperature gauge, and a stirring device together with ethyl acetate, and the mixture was subjected to a reaction in a stream of a nitrogen gas at 60° C. for 7 hours. After that, ethyl acetate was added to the reaction liquid. Thus, a solution containing a (meth)acrylic polymer (b-1) having a weight-average molecular weight of 1,600,000 was obtained (solid content concentration: 30 wt %).

### Production Example 7

### (Meth)Acrylic Polymer (B-2)

98.5 Parts by weight of butyl acrylate, 1 part by weight of 4-hydroxybutyl acrylate, 1 part by weight of acrylic acid, 15 parts by weight of benzyl acrylate, and 1 part by weight of AIBN as an initiator were loaded into a reaction vessel mounted with a cooling tube, a nitrogen-introducing tube, a temperature gauge, and a stirring device together with ethyl acetate, and the mixture was subjected to a reaction in a stream of a nitrogen gas at 60° C. for 7 hours. After that, ethyl acetate was added to the reaction liquid. Thus, a solution containing a (meth)acrylic polymer (b-2) having a weight-average molecular weight of 1,650,000 was obtained (solid content concentration: 30 wt %).

### Example 1

### Production of Polarizing Plate

### Preparation of Pressure-Sensitive Adhesive

The solution containing the (meth)acrylic polymer (B-1) obtained in Production Example 6 was compounded with 0.1 part by weight of trimethylolpropane xylylene diisocyanate (manufactured by Mitsui Chemicals, Inc., trade name: “TAKENATE D110N”) and 0.3 part by weight of dibenzoyl peroxide as cross-linking agents, and 0.1 part by weight of γ-glycidoxypropylmethoxysilane (manufactured by Shin-Etsu Chemical Co., Ltd., trade name: “KBM-403”) as a silane coupling agent per 100 parts by weight of the solid content of the solution. Thus, a pressure-sensitive adhesive solution was obtained.

(Production of Polarizing Plate with Pressure-Sensitive Adhesive Layer)

The resultant pressure-sensitive adhesive solution was uniformly applied to the surface of a polyethylene terephthalate film (base material) treated with a silicone-based peeling agent by using a fountain coater, and was dried in an air-circulating thermostatic oven at 155° C. for 2 minutes. Thus, a pressure-sensitive adhesive layer having a thickness of 20 μm was formed on the surface of the base material. Next, the thermoplastic resin base material of the laminate A-1 obtained in Production Example 2 was peeled, and the pressure-sensitive adhesive layer was transferred onto the exposed polarizing film. Thus, a polarizing plate with a pressure-sensitive adhesive layer (protective film (40 μm)/polarizing film (5 μm)/pressure-sensitive adhesive layer (20 μm)) was obtained.

### Examples 2 to 8

### Production of Polarizing Plate

Polarizing plates with pressure-sensitive adhesive layers were each obtained in the same manner as in Example 1 except that: those shown in Table 1 were used as the laminate including the polarizing film and the protective film, the (meth)acrylic polymer, and the cross-linking agent; and the thickness of the pressure-sensitive adhesive layer was set to a thickness shown in Table 1. It should be noted that in Example 8, lithium trifluoromethanesulfonylimide (manufactured by Morita Chemical Industries Co., Ltd.) was compounded as an antistatic agent upon preparation of a pressure-sensitive adhesive solution.

TABLE 1

| | | Pressure-sensitive adhesive | | | | | | |
|---|---|---|---|---|---|---|---|---|
| | | | | Cross-linking agent | | | | |
| | | | | Peroxide-based | Isocyanate-based | Silane coupling | Ionic compound | Thick- |
| | | (Meth)acrylic | | cross-linking | cross-linking agent | agent | (lithium | ness of |
| | Laminate | polymer | | agent (dibenzoyl | (trimethylolpropane | (γ-glycidoxypro- | trifluoromethane | pressure- |
| | of protec- | | Compounding | peroxide) | xylylene diisocyanate) | pylmethoxysilane) | sulfonylimide) | sensitive |
| | tive film and | | amount | Compounding | Compounding | Compounding | Compounding | adhesive |
| | polarizing | | (part(s) by | amount (part(s) | amount (part(s) | amount (part(s) | amount (part(s) by | layer |
| | film | Kind | weight) | by weight) | by weight) | by weight) | weight) | (μm) |
| Example 1 | A-1 | B-1 | 100 | 0.3 | 0.1 | 0.1 | — | 20 |
| Comparative | | | | | | | | |
| Example 1 | | | | | | | | |
| Example 2 | A-2 | B-1 | 100 | 0.3 | 0.1 | 0.1 | — | 20 |
| Comparative | | | | | | | | |
| Example 2 | | | | | | | | |
| Example 3 | A-1 | B-1 | 100 | 0.3 | 0.1 | 0.1 | — | 13 |
| Example 4 | A-1 | B-1 | 100 | 0.3 | 0.1 | 0.1 | — | 24 |
| Example 5 | A-1 | B-1 | 100 | 0.3 | 0.2 | 0.1 | — | 20 |
| Example 6 | A-1 | B-1 | 100 | 0.3 | 0.02 | 0.1 | — | 20 |
| Example 7 | A-1 | B-2 | 100 | 0.3 | 0.1 | 0.1 | — | 20 |
| Example 8 | A-1 | B-1 | 100 | 0.3 | 0.1 | 0.1 | 1 | 20 |
| Comparative | A-1 | B-1 | 100 | 0.3 | 0.1 | 0.1 | — | 10 |
| Example 3 | | | | | | | | |
| Comparative | A-1 | B-1 | 100 | 0.3 | 1 | 0.1 | — | 20 |
| Example 4 | | | | | | | | |
| Comparative | A-1 | B-1 | 100 | 0.3 | 0.01 | 0.1 | — | 20 |
| Example 5 | | | | | | | | |
| Comparative | A-3 | B-1 | 100 | 0.3 | 0.1 | 0.1 | — | 20 |
| Example 6 | | | | | | | | |
| Reference | A-4 | B-1 | 100 | 0.3 | 0.1 | 0.1 | — | 20 |
| Example 1 | | | | | | | | |

### Comparative Example 1

A pressure-sensitive adhesive solution was obtained in the same manner as in Example 1.

The resultant pressure-sensitive adhesive solution was uniformly applied to the surface of a polyethylene terephthalate film (base material) treated with a silicone-based peeling agent by using a fountain coater, and was dried in an air-circulating thermostatic oven at 155° C. for 2 minutes. Thus, a pressure-sensitive adhesive layer having a thickness of 20 μm was formed on the surface of the base material. Next, the pressure-sensitive adhesive layer was transferred onto the protective film of the laminate A-1 obtained in Production Example 2, and then the thermoplastic resin base material was peeled. Thus, a polarizing plate (pressure-sensitive adhesive layer (20 μm)/protective film (40 μm)/polarizing film (5 μm)) was obtained.

### Comparative Example 2

A polarizing plate (pressure-sensitive adhesive layer (20 μm)/protective film (50 μm)/polarizing film (5 μm)) was obtained in the same manner as in Comparative Example 1 except that the laminate A-2 was used instead of the laminate A-1.

### Comparative Example 3

A polarizing plate (protective film (40 μm)/polarizing film (5 μm)/pressure-sensitive adhesive layer (10 μm)) was obtained in the same manner as in Example 1 except that the thickness of the pressure-sensitive adhesive layer was changed to 10 μm.

### Comparative Example 4

A polarizing plate (protective film (40 μm)/polarizing film (5 μm)/pressure-sensitive adhesive layer (20 μm)) was obtained in the same manner as in Example 1 except that the compounding amount of trimethylolpropane xylylene diisocyanate (manufactured by Mitsui Chemicals, Inc., trade name: “TAKENATE D110N”) was changed from 0.1 part by weight to 1 part by weight.

### Comparative Example 5

A polarizing plate (protective film (40 μm)/polarizing film (5 μm)/pressure-sensitive adhesive layer (20 μm)) was obtained in the same manner as in Example 1 except that the compounding amount of trimethylolpropane xylylene diisocyanate (manufactured by Mitsui Chemicals, Inc., trade name: “TAKENATE D110N”) was changed from 0.1 part by weight to 0.01 part by weight.

### Comparative Example 6

A polarizing plate (protective film (40 μm)/polarizing film (20 μm)/pressure-sensitive adhesive layer (20 μm)) was obtained in the same manner as in Example 1 except that the laminate A-3 was used instead of the laminate A-1.

### Reference Example 1

A polarizing plate (protective film (40 μm)/polarizing film (20 μm)/protective film (40 μm)/pressure-sensitive adhesive layer (20 μm)) was obtained in the same manner as in Example 1 except that: the laminate A-4 was used instead of the laminate A-1; and the pressure-sensitive adhesive layer was transferred onto the protective film.

<Evaluation>

The optical laminates or polarizing plates with pressure-sensitive adhesive layers obtained in Examples, Comparative Examples, and Reference Example were subjected to the following evaluations. The results are shown in Table 2.

(Creep Amount of Pressure-Sensitive Adhesive Layer)

An end portion (measuring 10 mm wide by 10 mm long) of a polarizing plate with a pressure-sensitive adhesive layer cut so as to measure 10 mm wide by 50 mm long was bonded to a stainless plate through a pressure-sensitive adhesive layer, and the resultant was treated in an autoclave at 50° C. and 5 atmospheres for 15 minutes, followed by standing at room temperature for 1 hour. After that, the shift amount (deformation amount) of the pressure-sensitive adhesive layer when a load of 500 g (tensile load) was applied to an end portion opposite to the end portion bonded to the stainless plate under 23° C. for 1 hour was measured, and the measured value was defined as the creep amount of the pressure-sensitive adhesive layer (laser-type creep tester).

(Durability Evaluation 1-Foaming and Peeling)

An evaluation sample was produced by bonding the pressure-sensitive adhesive layer side of an optical laminate or a polarizing plate with a pressure-sensitive adhesive layer to a non-alkali glass (manufactured by Corning Incorporated, trade name: “EG-XG”, thickness: 0.7 mm). The evaluation sample was treated in an autoclave at 50° C. and 5 atmospheres for 15 minutes, and was then loaded into an oven at 80° C. and left to stand for 500 hours.

The presence or absence of the peeling and foaming of the optical laminate or the polarizing plate with a pressure-sensitive adhesive layer after a lapse of 500 hours was visually observed.

In the table, a product in which neither peeling nor foaming was observed was evaluated as ⊚, a product in which peeling or foaming that could not be visually observed was observed was evaluated as ∘, a product in which slight peeling or foaming that was able to be visually observed was observed was evaluated as Δ, and a product in which distinct peeling or foaming was observed was evaluated as x.

In addition, the sample was loaded into a 60° C./90% RH thermo-hygrostat and left to stand for 500 hours, followed by an evaluation for its durability by the same criteria as those described above.

(Durability Evaluation 2-Appearance Abnormality in End Portion)

An evaluation sample was produced by bonding the pressure-sensitive adhesive layer side of a polarizing plate with a pressure-sensitive adhesive layer to a non-alkali glass (manufactured by Corning Incorporated, trade name: “EG-XG”, thickness: 0.7 mm). The evaluation sample was treated in an autoclave at 50° C. and 5 atmospheres for 15 minutes, and was then loaded into an oven at 80° C. and left to stand for 500 hours.

With regard to the optical laminate or the polarizing plate with a pressure-sensitive adhesive layer after a lapse of 500 hours, a lightness difference in an end portion of the polarizing plate caused by light leakage due to crossed Nicols was observed.

In the table, a product in which appearance abnormality in the end portion due to the lightness difference was absent was evaluated as o, and a product in which appearance abnormality was present was evaluated as x.

(Level Difference Followability)

As illustrated in a schematic view of FIG. 4, a polarizing plate with a pressure-sensitive adhesive layer was bonded to an adherend 300 having a level difference (height x=5 μm) formed by a PET film arranged on an inorganic alkali glass. The resultant was treated in an autoclave at 50° C. and 5 atmospheres for 15 minutes, and then a width a (floating width a) of a portion of the polarizing plate with a pressure-sensitive adhesive layer out of contact with the adherend owing to its floating was measured with an optical microscope. The polarizing plate was evaluated for its level difference followability by the following criteria based on the size of the floating width a. As the floating width reduces, the polarizing plate becomes more excellent in level difference followability.

⊚: The floating width a is less than 200 μm.
∘: The floating width a is from 200 μm to less than 400 μm.
Δ: The floating width a is 400 μm to less than 1,000 μm.
x: The floating width a is 1,000 μm or more.

TABLE 2

| | | | | | | | Evaluation | | | |
|---|---|---|---|---|---|---|---|---|---|---|
| | | | | | | | Durability | | | |
| | | Laminate | | | | | Evaluation 1 | | | |
| | | of | Thickness | Thickness | Thickness of | Creep amount of | (foaming and | | Durability | |
| | | protective | of | of | pressure-sensi- | pressure-sensi- | peeling) | | Evaluation 2 | Level |
| | Construction | film and | protective | polarizing | tive adhesive | tive adhesive | | Humidi- | (appearance | difference |
| | of polarizing | polarizing | film | film | layer | layer | | fica- | abnormality in | follow- |
| | plate | film | (μm) | (μm) | (μm) | (μm/h) | Heating | tion | end portion) | ability |
| Example 1 | Protective | A-1 | 40 | 5 | 20 | 120 | ⊚ | ⊚ | ◯ | ⊚ |
| Example 2 | film/polarizing | A-2 | 50 | 5 | 20 | 120 | ◯ | ⊚ | ◯ | ⊚ |
| Example 3 | film/pressure- | A-1 | 40 | 5 | 13 | 90 | ⊚ | ◯ | ◯ | ◯ |
| Example 4 | sensitive | A-1 | 40 | 5 | 24 | 150 | ◯ | ⊚ | ◯ | ⊚ |
| Example 5 | adhesive layer | A-1 | 40 | 5 | 20 | 90 | ⊚ | ⊚ | ◯ | ◯ |
| Example 6 | | A-1 | 40 | 5 | 20 | 240 | ◯ | ⊚ | ◯ | ⊚ |
| Example 7 | | A-1 | 40 | 5 | 20 | 120 | ⊚ | ⊚ | ◯ | ⊚ |
| Example 8 | | A-1 | 40 | 5 | 20 | 120 | ⊚ | ⊚ | ◯ | ⊚ |
| Comparative | Pressure- | A-1 | 40 | 5 | 20 | 120 | Δ | ◯ | X | ⊚ |
| Example 1 | sensitive | | | | | | | | | |
| Comparative | adhesive layer/ | A-2 | 50 | 5 | 20 | 120 | Δ | ◯ | X | ⊚ |
| Example 2 | protective | | | | | | | | | |
| | film/polarizing | | | | | | | | | |
| | film | | | | | | | | | |
| Comparative | Protective | A-1 | 40 | 5 | 10 | 45 | Δ | Δ | ◯ | X |
| Example 3 | film/polarizing | | | | | | | | | |
| Comparative | film/pressure- | A-1 | 40 | 5 | 20 | 40 | Δ | Δ | ◯ | X |
| Example 4 | sensitive | | | | | | | | | |
| Comparative | adhesive layer | A-1 | 40 | 5 | 20 | 300 | X | ◯ | ◯ | ⊚ |
| Example 5 | | | | | | | | | | |
| Comparative | | A-3 | 40 | 20 | 20 | 120 | X | X | ◯ | ⊚ |
| Example 6 | | | | | | | | | | |
| Reference | Protective | A-4 | 40, 40 | 5 | 20 | 120 | ⊚ | ⊚ | ◯ | ⊚ |
| Example 1 | film/polarizing | | | | | | | | | |
| | film/protective | | | | | | | | | |
| | film/pressure- | | | | | | | | | |
| | sensitive | | | | | | | | | |
| | adhesive layer | | | | | | | | | |

The polarizing plate with a pressure-sensitive adhesive layer of the present invention is suitably used for liquid crystal televisions, liquid crystal displays, liquid crystal panels of, for example, mobile phones, digital cameras, video cameras, portable game machines, car navigation systems, copying machines, printers, facsimile machines, timepieces, and microwave ovens, and anti-reflection plates of organic EL devices.

1. A polarizing plate with a pressure-sensitive adhesive layer, comprising a protective film, a polarizing film, and a pressure-sensitive adhesive layer in the stated order, wherein:
the polarizing plate with a pressure-sensitive adhesive layer has a total thickness of 90 μm or less,
the polarizing film has a thickness of 13 μm or less;
the pressure-sensitive adhesive layer has a thickness of from 12 μm to 25 μm; and
a creep amount when a load of 500 g is applied to the pressure-sensitive adhesive layer for 1 hour is from 80 μm/h to 260 μm/h.

2. The polarizing plate with a pressure-sensitive adhesive layer according to claim 1, wherein the pressure-sensitive adhesive layer contains a (meth)acrylic pressure-sensitive adhesive.

3. The polarizing plate with a pressure-sensitive adhesive layer according to claim 1, wherein when a pressure-sensitive adhesive surface of the polarizing plate with a pressure-sensitive adhesive layer is bonded to a non-alkali glass, and the resultant is left to stand under a 70° C. atmosphere for 200 hours, a shrinkage ratio of the polarizing plate with a pressure-sensitive adhesive layer in an absorption axis direction of the polarizing film is 0.4% or less.

4. The polarizing plate with a pressure-sensitive adhesive layer according to claim 1, wherein the protective film has a thickness of from 5 μm to 55 μm.

5. The polarizing plate with a pressure-sensitive adhesive layer according to claim 1, wherein the polarizing plate with a pressure-sensitive adhesive layer has a total thickness of 90 μm or less.

6. The polarizing plate with a pressure-sensitive adhesive layer according to claim 1, wherein:
the pressure-sensitive adhesive layer is formed of a pressure-sensitive adhesive containing a base polymer and a plurality of kinds of cross-linking agents; and
the plurality of kinds of cross-linking agents each comprise one of a peroxide-based cross-linking agent, an epoxy-based cross-linking agent, and an isocyanate-based cross-linking agent.

7. An optical laminate, comprising:
the polarizing plate with a pressure-sensitive adhesive layer of claim 1; and
an optical film arranged on the pressure-sensitive adhesive layer of the polarizing plate with a pressure-sensitive adhesive layer.

8. The optical laminate according to claim 7, wherein the optical film comprises a brightness enhancement film.
